(19) United States
(12) Patent Application Publication
(10) Pub. No.: US 2022/0283617 A1
(43) Pub. Date: Sep. 8, 2022

(54) ELECTRIC APPARATUS

(71) Applicant: GUANGDONG OPPO MOBILE TELECOMMUNICATIONS CORP., LTD., Dongguan (CN)

(72) Inventor: Yoji Okazaki, Yokohama (JP)

(21) Appl. No.: 17/752,109

(22) Filed: May 24, 2022

Related U.S. Application Data
(63) Continuation of application No. PCT/CN2019/121046, filed on Nov. 26, 2019.

(51) Int. Cl. G06F 1/20; G06F 1/16

(52) U.S. Cl. CPC G06F 1/203; G06F 1/1626; G06F 1/1686

(57) ABSTRACT

An electric apparatus according to the embodiments of the present disclosure includes a display, a camera module located at a back side of the display, the camera module including an optical lens and an imaging sensor to sense light through the optical lens to capture an image, a heatsink substrate to draw heat away from the imaging sensor, the imaging sensor being disposed on the heatsink substrate, a heat radiation plate connected to the heatsink substrate, and an enclosure storing the camera module, the heatsink substrate, and the heat radiation plate inside thereof, the enclosure enclosing the display. The heat radiation plate is a meta material that radiates heat toward an outside of the electric apparatus through the display or the enclosure.

### CROSS-REFERENCE TO RELATED APPLICATIONS

The present application is a continuation of International patent application No. PCT/CN2019/121046, filed on Nov. 26, 2019, which is incorporated herein by reference in its entirety.

### FIELD

The present disclosure relates to an electric apparatus.

### BACKGROUND

In recent years, the electric apparatus such as the mobile phone or smartphone has the high flame rate image sensor. In the electronic apparatus, long light exposure is used to get good low light performance. Furthermore, the video mode is started to be used frequently in the electronic apparatus. The high height camera module of the electric apparatus has begun to use image sensors with a large size of 1/1.4 inches or more. The electric apparatus using such a large size image sensor is suitable for performing the video mode.

For example, the electric apparatus such as the 5G smartphone has the heating problem. Especially, the camera module of the 5G smartphone has the heating problem from the image sensor. The sensor noises of the image sensor are due to increasing of the heating from the image sensor. Thus, the decrease of the heating from the image sensor module decreases the sensor noises. The sensor noises decreases the quality of the image generated by the 5G smartphone.

However, there is no effective solution to decrease the heating from the image sensor module for reducing the sensor noise. Because the enclosure of the 5G smartphone has high temperature, the image sensor can't reduce the heating from itself.

### SUMMARY

The present disclosure aims to solve at least one of the technical problems mentioned above. Accordingly, the present disclosure needs to provide an electric apparatus.

In accordance with the present disclosure, an electric apparatus may include:

a display;

a camera module located at a back side of the display, the camera module comprising an optical lens and an imaging sensor to sense a light through the optical lens to capture an image;

a heatsink substrate to draw heat away from the imaging sensor, the imaging sensor being disposed on the heatsink substrate;

a heat radiation plate connected to the heatsink substrate; and

an enclosure storing the camera module, the heatsink substrate, and the heat radiation plate inside thereof, the enclosure enclosing the display;

wherein the heat radiation plate is a meta material that radiates heat toward an outside of the electric apparatus through the display or the enclosure.

In some embodiments, the meta material may radiate electromagnetic waves in response to the heat transferred from the heatsink substrate.

In some embodiments, the electromagnetic wave emitted from the meta material may pass through a color filter of the display.

In some embodiments, the electromagnetic waves may be infrared rays.

In some embodiments, a peak frequency band of the emissivity of the electromagnetic waves of the meta material may be different from a peak frequency band of the absorption coefficient of the enclosure or the display.

In some embodiments, the heat radiation plate may be have a radiation surface facing the enclosure and a connection surface facing the heatsink substrate.

In some embodiments, a plurality of holes arranged periodically may be formed on the radiation surface of the heat radiation plate.

In some embodiments, a depth of the hole may be 4 μm, an inner diameter of the holes may be 3 μm, and an arrangement period of the hole may be 5 μm.

In some embodiments, a thickness of the meta material may be in a range from 10 μm to 200 μm.

In some embodiments, the imaging sensor may be disposed on the heatsink substrate.

In some embodiments, the electric apparatus may further comprise a first adhesive layer that bonds the imaging sensor and the heatsink substrate, and a second adhesive layer that bonds the heatsink substrate and the heat radiation plate.

In some embodiments, the heatsink substrate may have a first surface facing the imaging sensor and a second surface facing the meta material,

wherein the first surface of the heatsink substrate is connected to a back surface of the imaging sensor by the first adhesive layer, and

wherein the connection surface of the heat radiation plate is connected to the second surface of the heatsink substrate by the second adhesive layer.

In some embodiments, the first adhesive layer and the second adhesive layer may have thermal conductivity.

In some embodiments, the radiation surface of the heat radiation plate may be separated from an inner face of the enclosure.

In some embodiments, the radiation surface of the heat radiation plate may be in contact with an inner face of the enclosure.

In some embodiments, the radiation surface of the heat radiation plate may be separated from an inner face of the display.

In some embodiments, the radiation surface of the heat radiation plate may be in contact with an inner face of the display.

In some embodiments, the enclosure may comprises a main body portion facing the display, and a peripheral portion located around the main body portion, and

wherein the display is combined with the peripheral portion of the enclosure so that a back side of a display surface of the display faces an inner surface of the main body of the enclosure.

In some embodiments, the electric apparatus may further comprise a gyro sensor that detects angular velocity and a drive IC (integrated circuit) that drives the camera module,

wherein the heatsink substrate draws heat away from the gyro sensor and the drive IC.

In some embodiments, the gyro sensor and the drive IC may be disposed on the heatsink substrate.

In some embodiments, the heat radiation plate may be placed between the heatsink substrate and an inner face of the enclosure or the display.

In some embodiments, the heatsink substrate may be a SUS (Stainless Used Steel) substrate or a Cu substrate.

In some embodiments, the meta material may be made of A1.

In some embodiments, the enclosure may be made of a plastic or a glass.

In some embodiments, the display may include a glass panel.

In some embodiments, the camera module may comprise an actuator that controls the optical lens.

### BRIEF DESCRIPTION OF THE DRAWINGS

These and/or other aspects and advantages of embodiments of the present disclosure will become apparent and more readily appreciated from the following descriptions made with reference to the drawings, in which:

FIG. 1 is a diagram illustrating an example of an external configuration of the front side (display side) of an electric apparatus according to embodiments of the present disclosure;

FIG. 2 is a diagram illustrating an example of an external configuration of the back side (enclosure side) of the electric apparatus according to embodiments of the present disclosure;

FIG. 3 is a cross sectional view showing an example of a cross section of the electric apparatus taken along the line X-X of the electric apparatus of FIG. 1;

FIG. 4 is a plan view showing an example of a configuration focusing on the vicinity of a camera module of the electric apparatus shown in FIG. 2;

FIG. 5A is a cross sectional view showing an example of a configuration focusing on the vicinity of the camera module;

FIG. 5B is a cross sectional view showing the other example of a configuration focusing on the vicinity of the camera module;

FIG. 6A is a plan view showing an example of the appearance of a heat radiation plate that is a meta material;

FIG. 6B is a cross-sectional view showing an example of a cross-sectional configuration of the heat radiation plate along the line Y-Y of the heat radiation plate of FIG. 6A;

FIG. 7 is a diagram illustrating an example of a heat radiation model of the heat radiation plate that is a meta material;

FIG. 8 is a diagram illustrating an example of the relationship between the emissivity and the wavelength of the meta material, and the relationship between the absorption coefficient of the epoxy resin and the wavelength; and

FIG. 9 is a plan view showing a modification of the configuration focusing on the vicinity of the camera module, gyro sensor and the drive IC.

### DETAILED DESCRIPTION

Embodiments of the present disclosure will be described in detail and examples of the embodiments will be illustrated in the accompanying drawings. The same or similar elements and the elements having same or similar functions are denoted by like reference numerals throughout the descriptions. The embodiments described herein with reference to the drawings are explanatory, which aim to illustrate the present disclosure, but shall not be construed to limit the present disclosure.

Electric apparatus 100

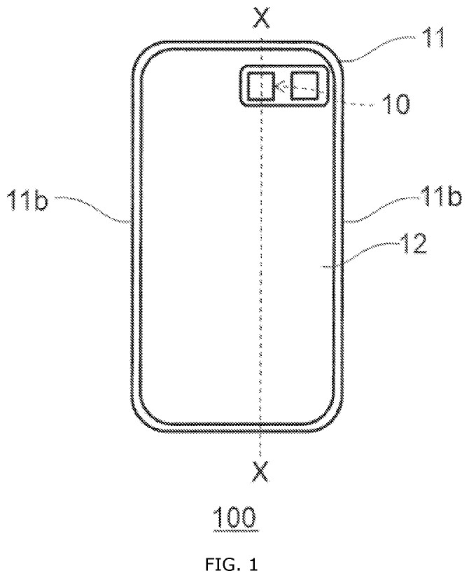

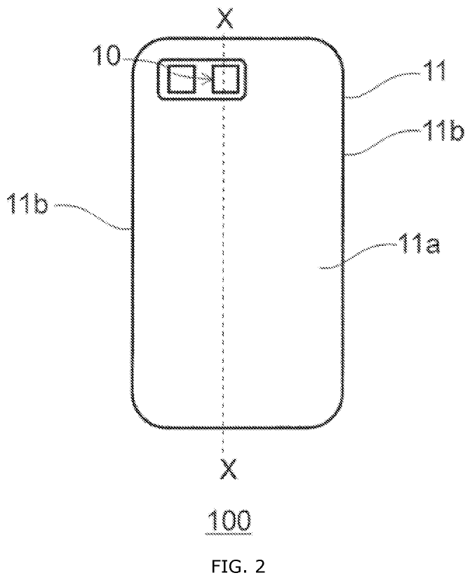

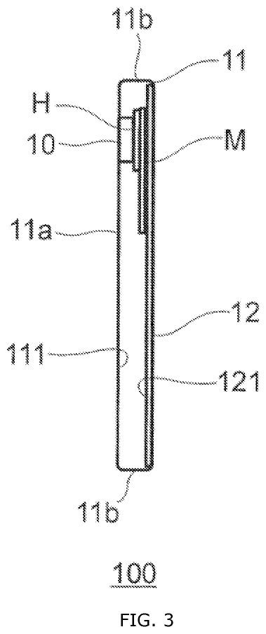

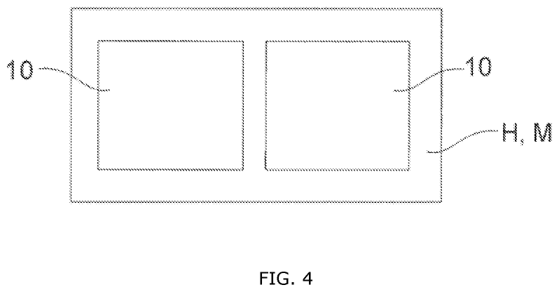

FIG. 1 is a diagram illustrating an example of an external configuration of the front side (display side) of an electric apparatus 100 according to embodiments of the present disclosure. Furthermore, FIG. 2 is a diagram illustrating an example of an external configuration of the back side (enclosure side) of the electric apparatus 100 according to embodiments of the present disclosure. Furthermore, FIG. 3 is a cross sectional view showing an example of a cross section of the electric apparatus 100 taken along the line X-X of the electric apparatus of FIG. 1. Furthermore, FIG. 4 is a plan view showing an example of a configuration focusing on the vicinity of a camera module 10 of the electric apparatus 100.

As shown in FIGS. 1 to 4, the electric apparatus 100 includes a camera module 10, an enclosure 11, a display 12, a heatsink substrate H, and a heat radiation plate M.

For example, the electric apparatus 100 can be a smartphone. Especially, the smartphone is 5G (5th Generation) smartphone.

However, the electric apparatus 100 may be various kinds of devices such a multifunctional mobile device, a laptop computer, a desktop computer, a tablet computer and so on.

Display 12

The display 12 is substantially transparent and covers substantially all area of the front surface of electric apparatus 100. In other words, the display 12 covers almost the entire front surface of the electric apparatus 100 and it is so called a full cover display or an under-display camera.

The display 12 includes a plurality of electrical elements for displaying images. For example, the display 20 may include a plurality of electrical elements such as switching elements, light emitting elements, capacitors, wires, and so on.

The display 12 is not limited to a display formed of the organic light emitting diodes but may be formed of other kinds of transparent display such as a liquid crystal display (LCD) or the like. Furthermore, the display 12 includes a glass panel. The glass panel is not electromagnetically shielded.

Enclosure 11

As shown in FIGS. 1 to 3, the enclosure 11 includes a main body portion 11a facing the display 12, and a peripheral portion 11b located around the main body portion 11a.

In addition, the display 12 is combined with the peripheral portion 11b of the enclosure 11 so that the back side (the inner surface) of the display surface (the outer surface) of the display 12 faces the inner surface 111 of the main body 11a of the enclosure 11.

Furthermore, as shown in FIGS. 1 to 3, the enclosure 11 stores the camera module 10, the heatsink substrate H, and the heat radiation plate M inside thereof.

Furthermore, preferably, a material that is not electromagnetically shielded is selected as a material of the enclosure 11. Thus, for example, the enclosure 11 is made of a plastic such as Epoxy resin, or a glass.

Camera module 10

The camera module 10 is located behind the display 12. In the embodiments, the camera module 10 is located at a back side of the display 12 and located at the center of an upper area of the electric apparatus 100 of FIGS. 1 to 3. Especially, as shown in FIG. 3, the camera module 10 is disposed on the heatsink substrate H.

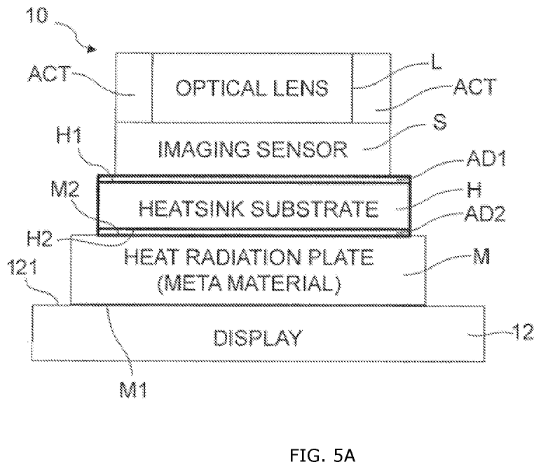

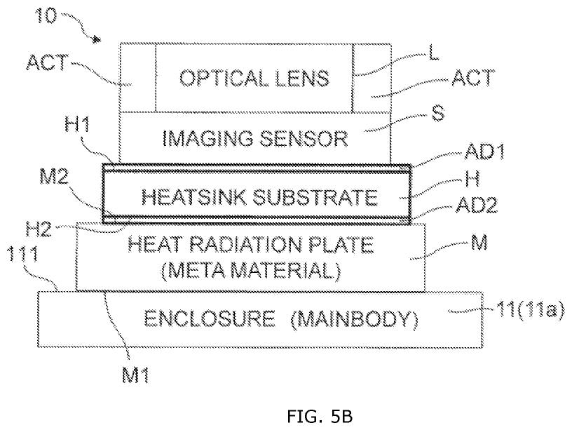

FIG. 5A is a cross sectional view showing an example of a configuration focusing on the vicinity of the camera module 10. Furthermore, FIG. 5B is a cross sectional view showing another example of a configuration focusing on the vicinity of the camera module 10.

As shown in FIGS. 5A and 5B, the camera module 10 includes an optical lens L and an imaging sensor S to sense light through the optical lens L to capture an image. The optical lens L may include one or more lenses. The optical lens L gathers the light which has passed through the optical lens L and focuses the light on the imaging sensor S. The imaging sensor S senses the light to create an image.

Furthermore, as shown in FIGS. 5A and 5B, the camera module 10 further includes actuators ACT that control the optical lens L (For example, AF: Auto Focus, OIS: Optical Image Stabilizer, and so on).

Heatsink substrate H

As shown in FIG. 3, the imaging sensor S is disposed on the heatsink substrate H. The heatsink substrate H draws the heat away from the imaging sensor S. For example, the heatsink substrate H may be a SUS (Stainless Used Steel) substrate or a Cu substrate.

Especially, as shown in FIGS. 5A and 5B, the electric apparatus 100 further comprises a first adhesive layer AD1 and a second adhesive layer AD2. The first adhesive layer AD1 bonds the imaging sensor S and the heatsink substrate H. The second adhesive layer AD2 bonds the heatsink substrate H and the heat radiation plate M.

As shown in FIGS. 5A and 5B, the heatsink substrate H has a first surface H1 facing the imaging sensor and a second surface H2 facing the heat radiation plate M. The first surface H1 is opposite to the second surface H2. Furthermore, the first surface H1 of the heatsink substrate H is connected to the back surface of the imaging sensor S by the first adhesive layer AD1. Furthermore, a connection surface M2 of the heat radiation plate M is connected to the second surface H2 of the heatsink substrate H by the second adhesive layer AD2.

For example, the first adhesive layer AD1 and the second adhesive layer AD2 have thermal conductivity. Therefore, the heat is transferred from the image sensor S to the heat radiation plate M through the heatsink substrate H.

Heat radiation plate M

As shown in FIG. 3, the heat radiation plate M is placed between the heatsink substrate H and an inner face 121 of the display 12 (FIG. 5A). However, as a modification, the heat radiation plate M may be placed between the heatsink substrate H and an inner face 111 of the enclosure 11 (FIG. 5B). Furthermore, as shown in FIG. 3, the heat radiation plate M is connected to the heatsink substrate H.

The heat radiation plate M is a meta material that radiates heat toward an outside of the electric apparatus 100 through the display 12 or the enclosure 11. For example, the meta material M is made of A1. The meta material radiates electromagnetic waves in response to the heat transferred from the heatsink substrate H. For example, the electromagnetic waves are infrared rays.

Furthermore, for example, the electromagnetic wave emitted from the heat radiation plate (the meta material) M passes through a color filter of the display 12. For example, the peak frequency band of the emissivity of the electromagnetic waves of the meta material M is different from the peak frequency band of the absorption coefficient of the display 12 or the enclosure 10.

Especially, as shown in FIGS. 5A and 5B, the heat radiation plate (the meta material) M has a radiation surface M1 facing the enclosure and a connection surface M2 facing the heatsink substrate H.

For example, as shown in FIGS. 5A, the radiation surface M1 of the heat radiation plate M may be in contact with the inner face 121 of the display 12. However, as a modification, the radiation surface M1 of the heat radiation plate M may be separated from the inner face of the display 12.

On the other hand, as shown in FIGS. 5B, as a modification, the radiation surface M1 of the heat radiation plate may be in contact with the inner face 111 of the enclosure 11 (the main body 11a). However, as a modification, the radiation surface M1 of the heat radiation plate M may be separated from the inner face 111 of the enclosure 11.

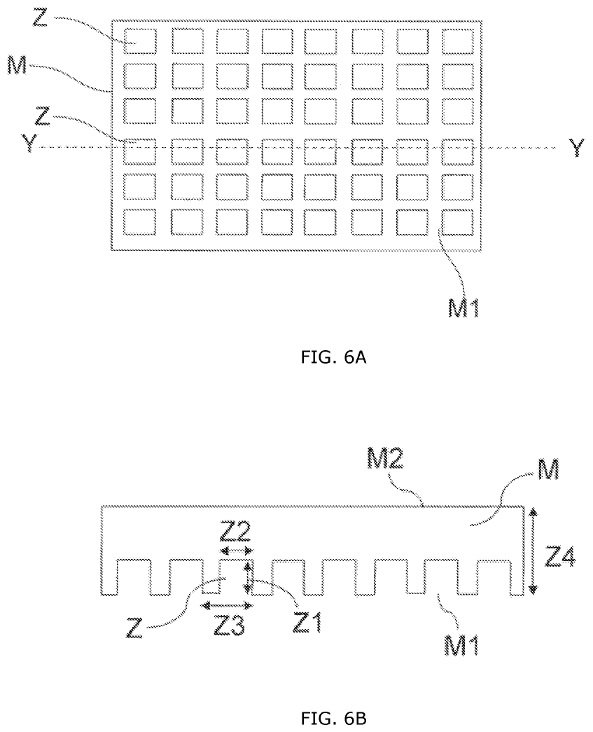

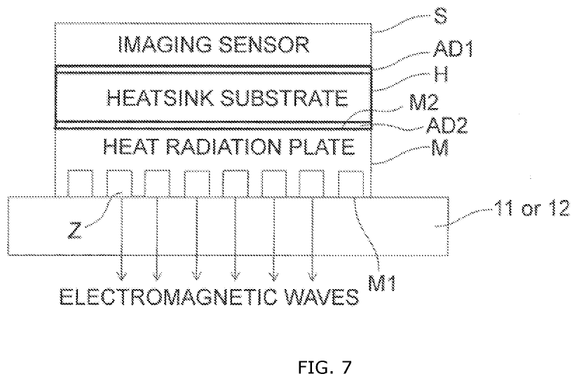

FIG. 6A is a plan view showing an example of the appearance of a heat radiation plate M that is a meta material. Furthermore, FIG. 6B is a cross-sectional view showing an example of a cross-sectional configuration of the heat radiation plate M along the line Y-Y of the heat radiation plate M of FIG. 6A. Furthermore, FIG. 7 is a diagram illustrating an example of a heat radiation model of the heat radiation plate M that is a meta material.

As shown in FIGS. 6A and 6B, a plurality of holes Z arranged periodically are formed on the radiation surface M1 of the heat radiation plate (meta material) M.

For example, as shown in FIG. 6B, a depth Z1 of the hole Z is, for example, 4 μm, an inner diameter Z2 of the hole Z is, for example, 3 μm, and an arrangement period Z3 of the hole Z is, for example, 5 μm. Furthermore, as shown in FIG. 6B, for example, a thickness Z4 of the meta material is in the range from 10 μm to 200 μm. As described above, the meta material is made of A1.

As shown in FIG. 7, the heat radiation plate M is the meta material that radiates heat toward an outside of the electric apparatus through the display 12 or the enclosure 11.

The heat radiation plate (the meta material) M radiates electromagnetic waves (for example, infrared rays) in response to the heat transferred from the heatsink substrate H. The electromagnetic wave emitted from the heat radiation plate (the meta material) M passes through a color filter of the display 12.

As described above, the peak frequency band of the emissivity of the electromagnetic waves of the meta material M is different from the peak frequency band of the absorption coefficient of the display 12 or the enclosure 11.

In the other word, the heat radiation plate M radiates the heat from the radiation surface M1 toward outside of the electric apparatus 100 via the display 12 or the enclosure 11.

Physical characteristic and Beneficial effect

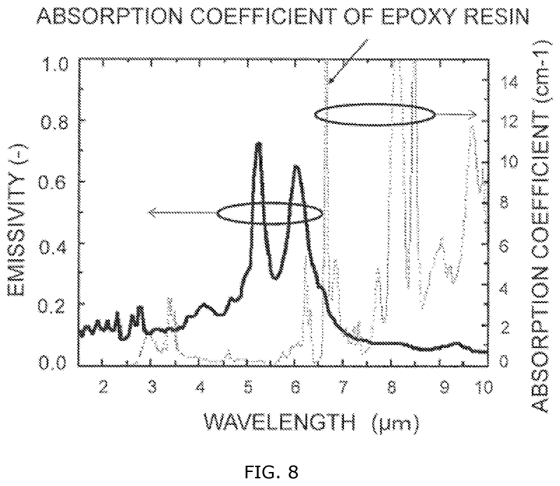

FIG. 8 is a diagram illustrating an example of the relationship between the emissivity and the wavelength of the meta material, and the relationship between the absorption coefficient of the epoxy resin and the wavelength.

As shown in FIG. 8, the emission peak of the meta material is divided into two. Since these two peaks exist in the low absorption region of the epoxy resin, the influence on the heat radiation of the meta material is low.

This meta material has a high emission peak in the 3-6 μm wavelength range, while the meta material has a very low thermal emissivity in other wavelength ranges. That is, this meta material has high wavelength selectivity.

Therefore, the heat radiation plate (the meta material) can radiate heat using 3-6 μm infrared wave length of which wave length is transparent against plastic and glass. However, 36 μm infrared wave length can't be transparent against metal.

The 5G smartphone enclosure always use glass/or plastic enclosure, because they are transparent against millimeter wave.

As described above, in the electric apparatus 100, the peak frequency band of the emissivity of the electromagnetic waves of the heat radiation plate (the meta material) M is different from the peak frequency band of the absorption coefficient of the display 12 or the enclosure 10. Therefore, the electromagnetic wave emitted from the heat radiation plate (the meta material) M passes through the display 12 or the enclosure 10.

In other word, the heat radiation plate (the meta material) M radiates the heating to outside of the electric apparatus 100 through the enclosure 11 or display 12 by emitting the electromagnetic waves.

Therefore, the heating from the image sensor S doesn't remain in the electric apparatus 100 such as smartphone. Thus, the heating of the image sensor S can be reduced and realize low sensor noise.

Furthermore, as the heat radiation plate M is around 200 μm and thin. Therefore, the total height of the camera module 10, the heatsink substrate H, and the heat radiation plate M can be reduced.

Modified example

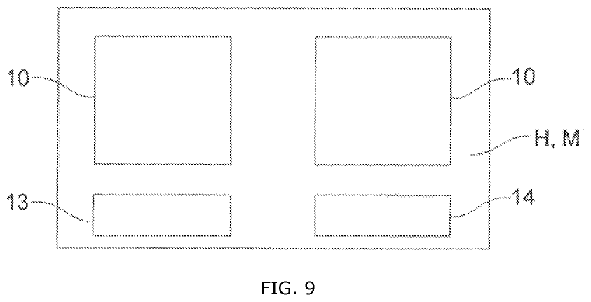

FIG. 9 is a plan view showing a modification of the configuration focusing on the vicinity of the camera module 10, a gyro sensor 13 and a drive IC 14.

As shown in FIG. 9, the electric apparatus 100 may further comprise a gyro sensor 13 that detects angular velocity. For example, As shown in FIG. 9, the gyro sensor 13 is disposed on the heatsink substrate H. In addition, the heatsink substrate H draws the heat away from the gyro sensor 13.

Furthermore, as shown in FIG. 9, the electric apparatus 100 may further comprise a drive IC (integrated circuit) 14 that drives the camera module 10. For example, as shown in FIG. 9, the drive IC 14 is disposed on the heatsink substrate H. In addition, the heatsink substrate H draws the heat away from the drive IC 14.

In some case, the gyro sensor 13 is located on the heatsink substrate H of the sensor. The gyro sensor signal has a low frequency drift due to thermal deviation while sensor shutter is on.

This drift causes the position fluctuations of OIS and the captured image has a blur due to the position change of OIS, especially in case of long exposure.

Therefore, if the heatsink substrate H can reduce the heating, the gyro sensor 13 also can reduce the heating, and then the drift can be reduced.

In the description of embodiments of the present disclosure, it is to be understood that terms such as “central”, “longitudinal”, “transverse”, “length”, “width”, “thickness”, “upper”, “lower”, “front”, “rear”, “left”, “right”, “vertical”, “horizontal”, “top”, “bottom”, “inner”, “outer”, “clockwise” and “counterclockwise” should be construed to refer to the orientation or the position as described or as shown in the drawings under discussion. These relative terms are only used to simplify description of the present disclosure, and do not indicate or imply that the device or element referred to must have a particular orientation, or constructed or operated in a particular orientation. Thus, these terms cannot be constructed to limit the present disclosure.

In addition, terms such as “first” and “second” are used herein for purposes of description and are not intended to indicate or imply relative importance or significance or to imply the number of indicated technical features. Thus, the feature defined with “first” and “second” may comprise one or more of this feature. In the description of the present disclosure, “a plurality of” means two or more than two, unless specified otherwise.

In the description of embodiments of the present disclosure, unless specified or limited otherwise, the terms “mounted”, “connected”, “coupled” and the like are used broadly, and may be, for example, fixed connections, detachable connections, or integral connections ; may also be mechanical or electrical connections; may also be direct connections or indirect connections via intervening structures; may also be inner communications of two elements, which can be understood by those skilled in the art according to specific situations.

In the embodiments of the present disclosure, unless specified or limited otherwise, a structure in which a first feature is “on” or “below” a second feature may include an embodiment in which the first feature is in direct contact with the second feature, and may also include an embodiment in which the first feature and the second feature are not in direct contact with each other, but are contacted via an additional feature formed therebetween. Furthermore, a first feature “on”, “above” or “on top of” a second feature may include an embodiment in which the first feature is right or obliquely “on”, “above” or “on top of” the second feature, or just means that the first feature is at a height higher than that of the second feature; while a first feature “below”, “under” or “on bottom of” a second feature may include an embodiment in which the first feature is right or obliquely “below”, “under” or “on bottom of” the second feature, or just means that the first feature is at a height lower than that of the second feature.

Various embodiments and examples are provided in the above description to implement different structures of the present disclosure. In order to simplify the present disclosure, certain elements and settings are described in the above. However, these elements and settings are only by way of example and are not intended to limit the present disclosure. In addition, reference numbers and/or reference letters may be repeated in different examples in the present disclosure. This repetition is for the purpose of simplification and clarity and does not refer to relations between different embodiments and/or settings. Furthermore, examples of different processes and materials are provided in the present disclosure. However, it would be appreciated by those skilled in the art that other processes and/or materials may be also applied.

Reference throughout this specification to “an embodiment”, “some embodiments”, “an exemplary embodiment”, “an example”, “a specific example” or “some examples” means that a particular feature, structure, material, or characteristics described in connection with the embodiment or example is included in at least one embodiment or example of the present disclosure. Thus, the appearances of the above phrases throughout this specification are not necessarily referring to the same embodiment or example of the present disclosure. Furthermore, the particular features, structures, materials, or characteristics may be combined in any suitable manner in one or more embodiments or examples.

Any process or method described in a flow chart or described herein in other ways may be understood to include one or more modules, segments or portions of codes of executable instructions for achieving specific logical functions or steps in the process, and the scope of a preferred embodiment of the present disclosure includes other implementations, in which it should be understood by those skilled in the art that functions may be implemented in a sequence other than the sequences shown or discussed, including in a substantially identical sequence or in an opposite sequence.

The logic and/or step described in other manners herein or shown in the flow chart, for example, a particular sequence table of executable instructions for realizing the logical function, may be specifically achieved in any computer readable medium to be used by the instruction execution system, device or equipment (such as the system based on computers, the system comprising processors or other systems capable of obtaining the instruction from the instruction execution system, device and equipment and executing the instruction), or to be used in combination with the instruction execution system, device and equipment. As to the specification, “the computer readable medium” may be any device adaptive for including, storing, communicating, propagating or transferring programs to be used by or in combination with the instruction execution system, device or equipment. More specific examples of the computer readable medium comprise but are not limited to: an electronic connection (an electronic device) with one or more wires, a portable computer enclosure (a magnetic device), a random access memory (RAM), a read only memory (ROM), an erasable programmable read-only memory (EPROM or a flash memory), an optical fiber device and a portable compact disk read-only memory (CDROM). In addition, the computer readable medium may even be a paper or other appropriate medium capable of printing programs thereon, this is because, for example, the paper or other appropriate medium may be optically scanned and then edited, decrypted or processed with other appropriate methods when necessary to obtain the programs in an electric manner, and then the programs may be stored in the computer memories.

It should be understood that each part of the present disclosure may be realized by the hardware, software, firmware or their combination. In the above embodiments, a plurality of steps or methods may be realized by the software or firmware stored in the memory and executed by the appropriate instruction execution system. For example, if it is realized by the hardware, likewise in another embodiment, the steps or methods may be realized by one or a combination of the following techniques known in the art: a discrete logic circuit having a logic gate circuit for realizing a logic function of a data signal, an application-specific integrated circuit having an appropriate combination logic gate circuit, a programmable gate array (PGA), a field programmable gate array (FPGA), etc.

Those skilled in the art shall understand that all or parts of the steps in the above exemplifying method of the present disclosure may be achieved by commanding the related hardware with programs. The programs may be stored in a computer readable storage medium, and the programs comprise one or a combination of the steps in the method embodiments of the present disclosure when run on a computer.

In addition, each function cell of the embodiments of the present disclosure may be integrated in a processing module, or these cells may be separate physical existence, or two or more cells are integrated in a processing module. The integrated module may be realized in a form of hardware or in a form of software function modules. When the integrated module is realized in a form of software function module and is sold or used as a standalone product, the integrated module may be stored in a computer readable storage medium.

The storage medium mentioned above may be read-only memories, magnetic disks, CD, etc.

Although embodiments of the present disclosure have been shown and described, it would be appreciated by those skilled in the art that the embodiments are explanatory and cannot be construed to limit the present disclosure, and changes, modifications, alternatives and variations can be made in the embodiments without departing from the scope of the present disclosure.

1. An electric apparatus, comprising:
a display;
a camera module located at a back side of the display, the camera module comprising an optical lens and an imaging sensor to sense light through the optical lens to capture an image;
a heatsink substrate to draw heat away from the imaging sensor, the imaging sensor being disposed on the heatsink substrate;
a heat radiation plate connected to the heatsink substrate; and
an enclosure storing the camera module, the heatsink substrate, and the heat radiation plate inside thereof, the enclosure enclosing the display;
wherein the heat radiation plate is a meta material that radiates heat toward an outside of the electric apparatus through the display or the enclosure.

2. The electric apparatus, according to claim 1, wherein the meta material radiates electromagnetic waves in response to the heat transferred from the heatsink substrate.

3. The electric apparatus, according to claim 1, wherein the electromagnetic wave emitted from the meta material passes through a color filter of the display.

4. The electric apparatus, according to claim 2, wherein the electromagnetic waves are infrared rays.

5. The electric apparatus, according to claim 2, wherein a peak frequency band of the emissivity of the electromagnetic waves of the meta material is different from a peak frequency band of the absorption coefficient of the enclosure or the display.

6. The electric apparatus, according to claim 2, wherein the heat radiation plate has a radiation surface facing the enclosure and a connection surface facing the heatsink substrate.

7. The electric apparatus, according to claim 6, wherein a plurality of holes arranged periodically are formed on the radiation surface of the heat radiation plate.

8. The electric apparatus, according to claim 7, wherein a depth of the hole is 4 μm, an inner diameter of the holes is 3 μm, and an arrangement period of the hole is 5 μm.

9. The electric apparatus, according to claim 7, wherein a thickness of the meta material is in a range from 10 μm to 200 μm.

10. The electric apparatus according to claim 1, wherein the imaging sensor is disposed on the heatsink substrate.

11. The electric apparatus according to claim 6, further comprising a first adhesive layer that bonds the imaging sensor and the heatsink substrate, and a second adhesive layer that bonds the heatsink substrate and the heat radiation plate.

12. The electric apparatus according to claim 11,
wherein the heatsink substrate has a first surface facing the imaging sensor and a second surface facing the meta material,
wherein the first surface of the heatsink substrate is connected to a back surface of the imaging sensor by the first adhesive layer, and
wherein the connection surface of the heat radiation plate is connected to the second surface of the heatsink substrate by the second adhesive layer.

13. The electric apparatus according to claim 12, wherein the first adhesive layer and the second adhesive layer have thermal conductivity.

14. The electric apparatus according to claim 12, wherein the radiation surface of the heat radiation plate is separated from an inner face of the enclosure and/or an inner face of the display; or
the radiation surface of the heat radiation plate is in contact with the inner face of the enclosure and/or the inner face of the display.

15. The electric apparatus according to claim 1,
wherein the enclosure comprises a main body portion facing the display, and a peripheral portion located around the main body portion, and
wherein the display is combined with the peripheral portion of the enclosure so that a back side of a display surface of the display faces an inner surface of the main body of the enclosure.

16. The electric apparatus according to claim 1, further comprising a gyro sensor that detects angular velocity and a drive IC (integrated circuit) that drives the camera module,
wherein the heatsink substrate draws heat away from the gyro sensor and the drive IC.

17. The electric apparatus according to claim 16, wherein the gyro sensor and the drive IC are disposed on the heatsink substrate.

18. The electric apparatus according to claim 1, wherein the heat radiation plate is placed between the heatsink substrate and an inner face of the enclosure or the display.

19. The electric apparatus, according to claim 1, satisfying any one or more of the following conditions:
the heatsink substrate is a SUS (Stainless Used Steel) substrate or a Cu substrate;
the meta material is made of A1;
the enclosure is made of a plastic or a glass; or
the display comprises a glass panel.

20. The electric apparatus, according to claim 1, wherein the camera module comprises an actuator that controls the optical lens.
